(19) United States
(12) Patent Application Publication
(10) Pub. No.: US 2025/0286300 A1
(43) Pub. Date: Sep. 11, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shunya TAKEUCHI, Mie (JP); Teruo HARA, Mie (JP); Hajime MATSUI, Mie (JP)

(21) Appl. No.: 18/862,553

(22) PCT Filed: Apr. 25, 2023
(86) PCT No.: PCT/JP2023/016302

§ 371 Date: Nov. 4, 2024

(30) Foreign Application Priority Data
May 13, 2022 (JP) 2022-079339

(51) Int. Cl. H01R 13/24; H01R 13/627; H01R 13/639

(52) U.S. Cl. CPC H01R 13/2492; H01R 13/6272; H01R 13/639

(57) ABSTRACT

A connector is to be connected to a wire including a core wire and an insulation coating covering an outer periphery of the core wire and extending in a front-rear direction, and provided with a terminal to be connected to the core wire, a connector housing for accommodating the terminal inside and a rear holder to be attached to a rear part of the connector housing. The terminal includes a terminal body and a slide portion slidable in the front-rear direction while being externally fit to the terminal body. The terminal body includes a sandwiching portion for sandwiching the core wire. The slide portion includes a core wire insertion opening, through which the core wire is inserted from behind, and a pressing portion for pressing the sandwiching portion against the core wire inserted through the core wire insertion opening.

### TECHNICAL FIELD

The present disclosure relates to a connector.

### BACKGROUND

Conventionally, a female terminal described in Japanese Patent Laid-Open Publication No. 2019-145208 (Patent Document 1 below) is known. The female terminal is provided with a terminal body including deformable upper and lower connection pieces extending in an extension direction and a slide portion movable in the extension direction with respect to the terminal body. By moving the slide portion with a core wire of a wire disposed between the upper and lower connection pieces, upper and lower contact portions provided in the slide portion press the upper and lower connection pieces against the core wire and the terminal body and the wire can be electrically connected. Further, a connector provided with a connector housing for accommodating the female terminal and a rear holder to be attached to a rear end part in the extension direction of the connector housing is described as a connector provided with this female terminal in Patent Document 1 below.

### PRIOR ART DOCUMENT

### Patent Document

Patent Document 1: JP 2019-145208 A

### SUMMARY OF THE INVENTION

### Problems to be Solved

The above connector is manufactured as follows. First, the female terminal is accommodated into the connector housing and the rear holder is assembled with the rear end part of the connector housing. In this state, the rear holder is held at a temporary locking position with respect to the connector housing. Subsequently, a wire is inserted into an insertion hole of the rear holder and a core wire of the wire is inserted into the inside of the female terminal. At this time, the core wire is disposed between the upper and lower connection pieces. Subsequently, by moving the slide portion forward with respect to the terminal body, the upper and lower contact portions press the upper and lower connection pieces against the core wire and the female terminal and the wire are connected. Finally, by moving the rear holder to a complete locking position forward of the temporary locking position to retain the female terminal in the connector housing, the manufacturing of the connector is completed.

In manufacturing the above connector, it is thought to provide a guide portion for guiding the insertion of the core wire into the inside of the female terminal on the inner wall of the insertion hole of the rear holder in order to reliably insert the core wire into the inside of the female terminal. For example, the guide portion is shaped to be located more inwardly of the insertion hole toward the front, and guides the core wire into the inside of the female terminal by sliding in contact with the core wire.

However, if an attempt is made to move the rear holder further rearward than the temporary locking position in the connector provided with the above guide portion, the guide portion may interfere with an insulation coating of the wire and it may not be possible to move the rear holder rearward. That is, it may not be possible to remove the rear holder from the connector. Thus, it becomes difficult to perform, for example, a repair operation of the female terminal and the like.

### Means to Solve the Problem

The present disclosure is directed to a connector to be connected to a wire including a core wire and an insulation coating covering an outer periphery of the core wire and extending in a front-rear direction, the connector being provided with a terminal to be connected to the core wire, a connector housing for accommodating the terminal inside and a rear holder to be attached to a rear part of the connector housing, the terminal including a terminal body and a slide portion slidable in the front-rear direction while being externally fit to the terminal body, the terminal body including a sandwiching portion for sandwiching the core wire, the slide portion including a core wire insertion opening, the core wire being inserted through the core wire insertion opening from behind, and a pressing portion for pressing the sandwiching portion against the core wire inserted through the core wire insertion opening, the rear holder including a body portion, an insertion hole penetrating through the body portion in the front-rear direction, the wire being inserted through the insertion hole, and a resilient piece extending from the body portion, the resilient piece being disposed on a front side inside the insertion hole, the resilient piece being resiliently deformable in a direction intersecting an extension direction of the wire, and the resilient piece being formed with a guide portion inclined inwardly of the insertion hole toward front.

### Effect of the Invention

According to the present disclosure, it is possible to provide a connector capable of guiding the insertion of a core wire into the inside of a terminal accommodated in a connector housing and including an easily removable rear holder.

### BRIEF DESCRIPTION OF THE DRAWINGS

FIG. 1 is a perspective view of a connector according to an embodiment.

FIG. 2 is a perspective view showing a state where a rear holder is held on a connector housing at a temporary locking position.

FIG. 3 is a section showing a state where a terminal having a slide portion disposed at a separation position with respect to a terminal body is accommodated in the connector housing and the rear holder is held at the temporary locking position with respect to the connector housing.

FIG. 4 is a section showing a state where a core wire is inserted into an insertion hole from the state of FIG. 3 and a front end part of the core wire slides in contact with a guide portion.

FIG. 5 is a section showing a state where the core wire is inserted into the inside of the terminal from the state of FIG. 4.

FIG. 6 is a section showing a state where the slide portion is moved to a pressing position with respect to the terminal body from the state of FIG. 5.

FIG. 7 is a section showing a state where the rear holder is moved to a complete locking position with respect to the connector housing from the state of FIG. 6.

FIG. 8 is a section showing a state where the rear holder is moved further rearward than the temporary locking position with respect to the connector housing after the manufacturing of the connector.

FIG. 9 is a view of the terminal when viewed from behind the rear holder.

FIG. 10 is a back view of the rear holder.

FIG. 11 is a perspective view of the rear holder.

FIG. 12 is a section of a resilient piece.

FIG. 13 is a perspective view showing the resilient pieces with an upper part of the rear holder omitted.

FIG. 14 is a perspective view of the slide portion.

FIG. 15 is a perspective view of the terminal body.

FIG. 16 is a side view of the terminal having the slide portion disposed at the pressing position with respect to the terminal body.

FIG. 17 is a side view of the terminal having the slide portion disposed at the separation position with respect to the terminal body.

### DETAILED DESCRIPTION TO EXECUTE THE INVENTION

### DESCRIPTION OF EMBODIMENTS OF PRESENT DISCLOSURE

First, embodiments of the present disclosure are listed and described.

(1) The connector of the present disclosure is to be connected to a wire including a core wire and an insulation coating covering an outer periphery of the core wire and extending in a front-rear direction, and provided with a terminal to be connected to the core wire, a connector housing for accommodating the terminal inside and a rear holder to be attached to a rear part of the connector housing, the terminal including a terminal body and a slide portion slidable in the front-rear direction while being externally fit to the terminal body, the terminal body including a sandwiching portion for sandwiching the core wire, the slide portion including a core wire insertion opening, the core wire being inserted through the core wire insertion opening from behind, and a pressing portion for pressing the sandwiching portion against the core wire inserted through the core wire insertion opening, the rear holder including a body portion, an insertion hole penetrating through the body portion in the front-rear direction, the wire being inserted through the insertion hole, and a resilient piece extending from the body portion, the resilient piece being disposed on a front side inside the insertion hole, the resilient piece being resiliently deformable in a direction intersecting an extension direction of the wire, and the resilient piece being formed with a guide portion inclined inwardly of the insertion hole toward front.

According to this configuration, the insertion of the core wire into the core wire insertion opening can be guided by the guide portion. If the rear holder is provided with the guide portion, the guide portion contacts the insulation coating when the rear holder is separated from the connector housing for the repair of the terminal or the like. Since the guide portion is provided on the resilient piece resiliently deformable in the direction intersecting the extension direction of the wire in the above configuration, the rear holder can be separated from the connector housing by the insulation coating resiliently deforming the resilient piece.

(2) Preferably, a tip part of the guide portion is proximate to the core wire insertion opening.

According to this configuration, the insertion of the core wire into the core wire insertion opening can be more easily guided by the guide portion.

(3) Preferably, the guide portion has a curved surface shape.

According to this configuration, the core wire is easily guided toward a center of the core wire insertion opening.

(4) Preferably, a radius of curvature of the tip part of the guide portion is smaller than a radius of curvature of a rear end part of the guide portion.

According to this configuration, the core wire is even more easily guided toward the center of the core wire insertion opening by the tip part of the guide portion.

(5) Preferably, the guide portion includes a first guide portion and a second guide portion continuously disposed in front of the first guide portion, and the second guide portion is more gently inclined than the first guide portion.

According to this configuration, the inclination of the core wire with respect to the insertion direction can be suppressed by the second guide portion near the core wire insertion opening while the position of the core wire is guided inwardly of the core wire insertion opening by the first guide portion. Thus, the insertion of the core wire into the core wire insertion opening is even more easily guided.

(6) Preferably, the rear holder includes a guiding portion projecting inwardly of the insertion hole from an inner wall of the insertion hole toward the front, and the guiding portion is disposed to face the guide portion in a resiliently deformable direction of the resilient piece.

According to this configuration, the insertion of the core wire into the core wire insertion opening can be even more easily guided by the guiding portion.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

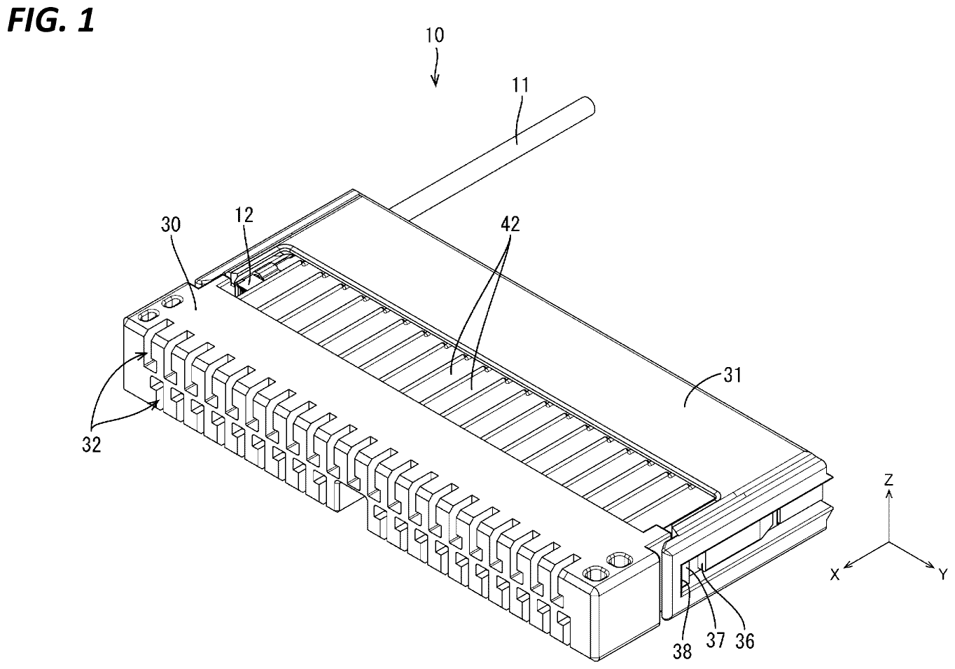

The embodiment of the present disclosure is described with reference to FIGS. 1 to 17. In the following description, a direction indicated by an arrow Z is referred to as an upward direction, a direction indicated by an arrow X is referred to as a forward direction and a direction indicated by an arrow Y is referred to as a leftward direction. Note that, for a plurality of identical members, only some members may be denoted by a reference sign and the other members may not be denoted by the reference sign.

### Connector

As shown in FIG. 1, a connector 10 according to this embodiment is provided with terminals 12 connected to ends of wires 11, a connector housing 30 including accommodating portions 32 for accommodating the terminals 12 and a rear holder 31 to be attached to a rear part of the connector housing 30.

### Wire

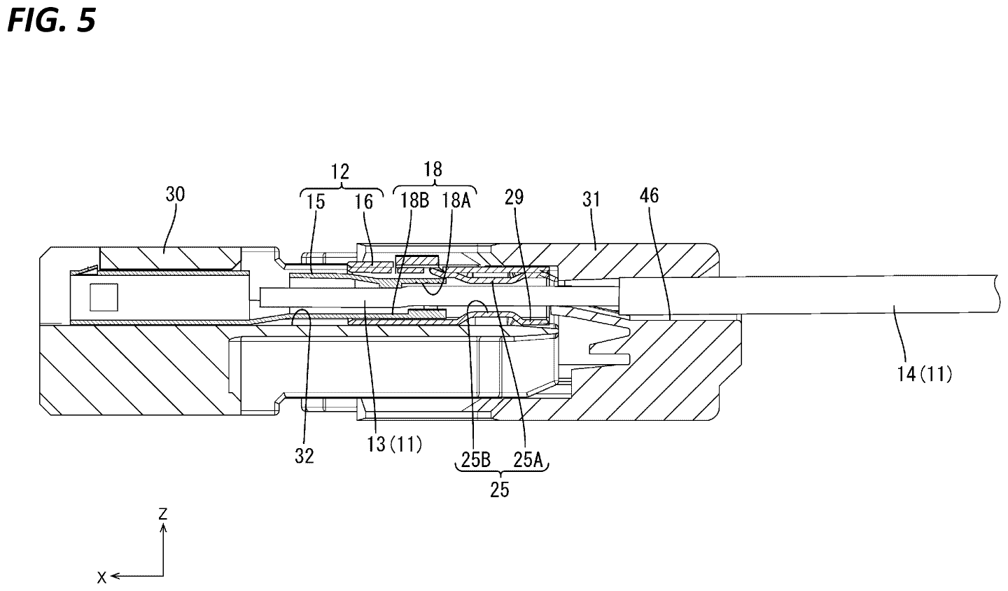

As shown in FIG. 5, the wire 11 is disposed to extend in the front-rear direction. The wire 11 is configured such that the outer peripheral surface of the core wire 13 is surrounded by an insulation coating 14 made of insulating synthetic resin. The core wire 13 is made of electrically conductive metal and constituted by a stranded wire formed by twisting a plurality of metal wires or one metal wire. In a front end part of the wire 11, the insulation coating 14 is removed to expose the core wire 13.

### Terminal

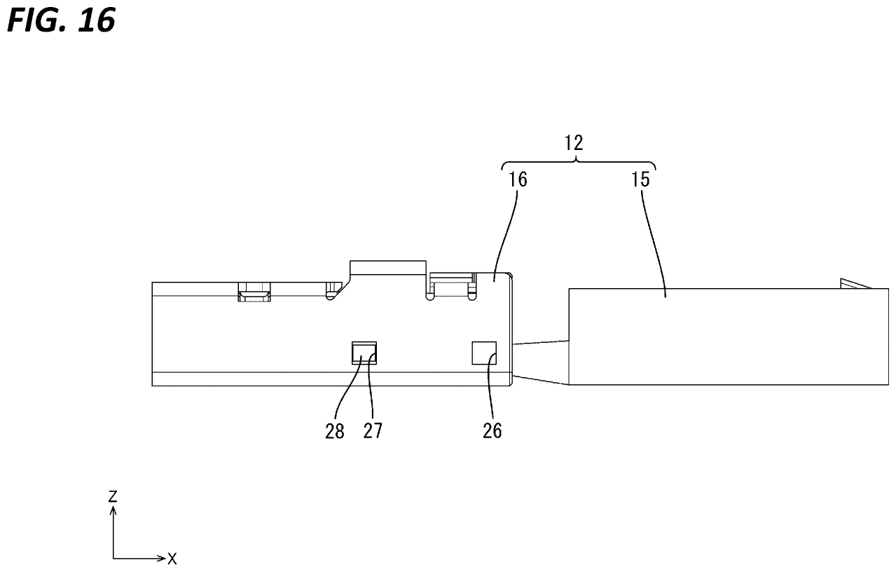

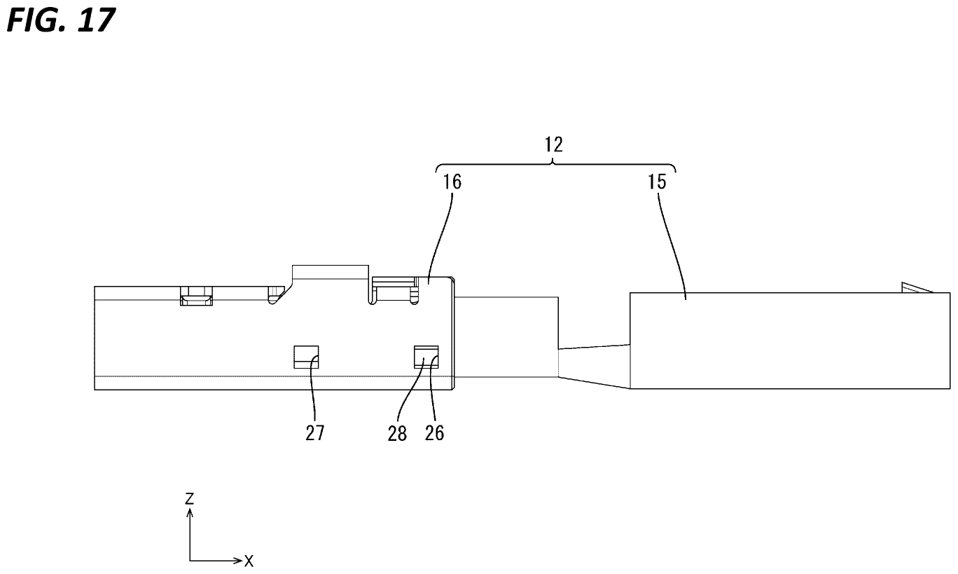

The terminal 12 is made of electrically conductive metal. As shown in FIGS. 16 and 17, the terminal 12 includes the terminal body 15 and a slide portion 16 movable in the front-rear direction with respect to the terminal body 15. The terminal body 15 and the slide portion 16 are formed into a predetermined shape by a known method such as press-working, cutting or casting. An arbitrary metal such as copper, copper alloy, aluminum, aluminum alloy or stainless steel can be appropriately selected as a metal constituting the terminal body 15 and the slide portion 16 if necessary. Plating layers may be formed on the surfaces of the terminal body 15 and the slide portion 16. An arbitrary metal such as tin, nickel or silver can be appropriately selected as a metal constituting the plating layers if necessary.

### Terminal Body

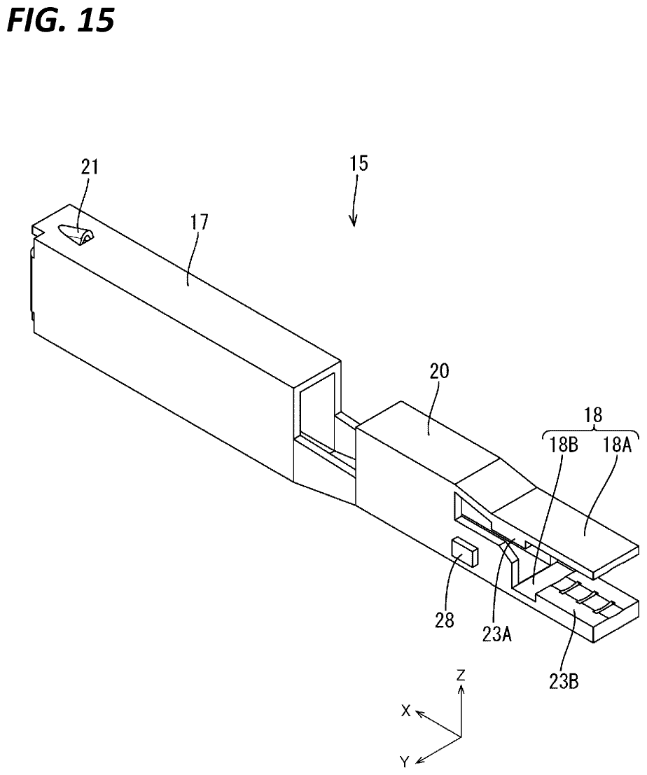

As shown in FIG. 15, a front part of the terminal body 15 serves as a connecting tube portion 17 in the form of a rectangular tube extending in the front-rear direction. A plate-like mating terminal (not shown) can be inserted into the connecting tube portion 17 from front. An unillustrated resilient contact piece is disposed inside the connecting tube portion 17 and the mating terminal inserted into the connecting tube portion 17 contacts the resilient contact piece. A locking lance 21 having a chevron shape projecting upward is formed on a front side of the upper wall of the connecting tube portion 17.

A base portion 20 in the form of a rectangular tube is provided behind the connecting tube portion 17. A locking projection 28 projecting outward is formed on a side wall of the base portion 20. A sandwiching portion 18 is provided in a rear end part of the base portion 20.

### Sandwiching Portion

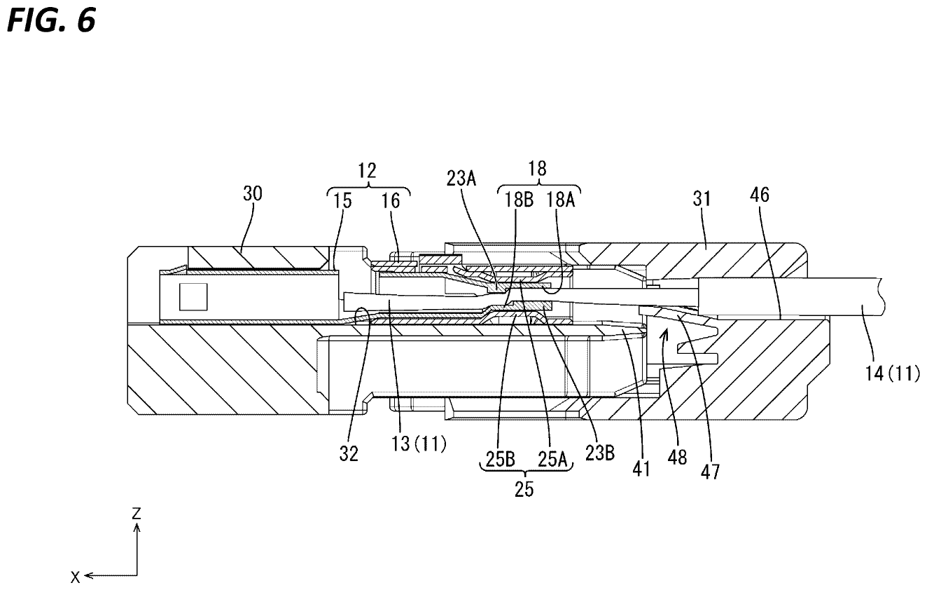

The sandwiching portion 18 includes an upper connection piece 18A extending rearward from a rear end part of the upper wall of the base portion 20 and a lower connection piece 18B extending rearward from a rear end part of the lower wall of the base portion 20. The upper and lower connection pieces 18A, 18B have a shape elongated in the front-rear direction and have substantially equal lengths in the front-rear direction. The upper and lower connection pieces 18A, 18B are formed to be resiliently deformable in the vertical direction with a rear end part of the base portion 20 as a fulcrum. As shown in FIG. 6, the lower surface of the upper connection piece 18A and the upper surface of the lower connection piece 18B can sandwich the core wire 13 and electrically connect the wire 11 and the terminal body 15.

As shown in FIG. 15, an upper holding protrusion 23A projecting downward is provided at a position in front of a rear end part on the lower surface of the upper connection piece 18A. A lower holding protrusion 23B projecting upward is provided on a rear end part of the upper surface of the lower connection piece 18B. The upper and lower holding protrusions 23A, 23B are provided at positions shifted in the front-rear direction.

### Slide Portion

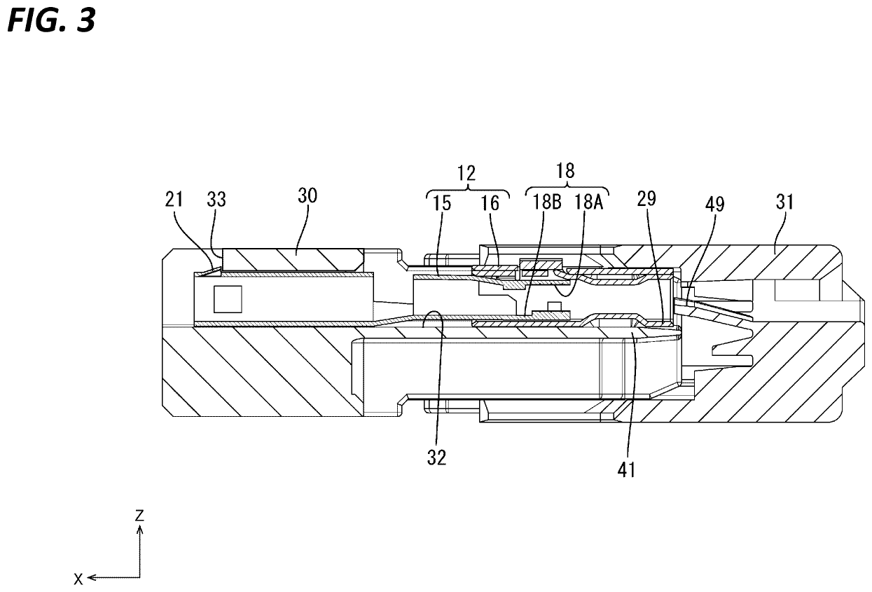

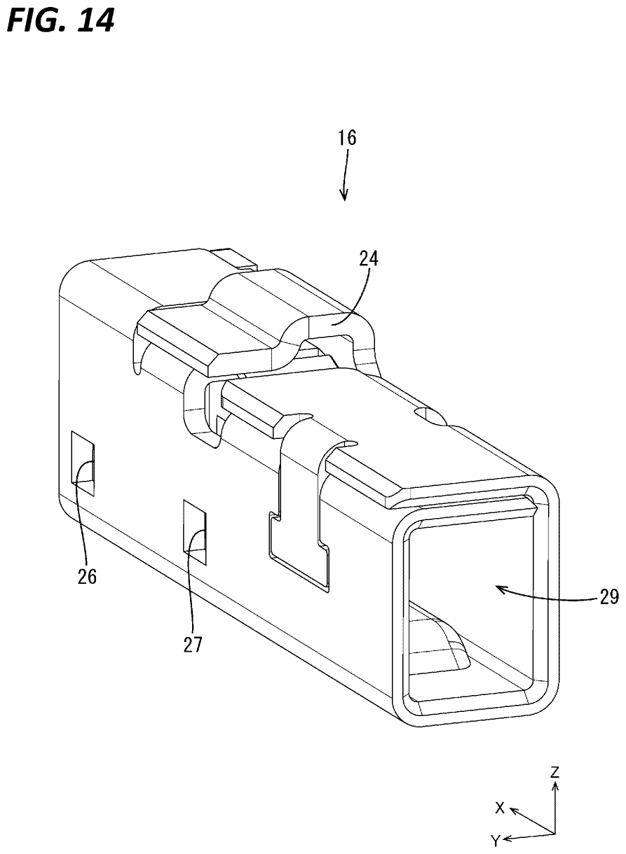

As shown in FIG. 14, the slide portion 16 is in the form of a rectangular tube extending in the front-rear direction. As shown in FIGS. 3 and 6, an internal cross-sectional shape of the slide portion 16 is the same as or somewhat larger than an external cross-sectional shape of a region of the terminal body 15 where the sandwiching portion 18 is provided. In this way, the slide portion 16 is fittable to the region of the terminal body 15 where the sandwiching portion 18 is provided.

### Pressing Portion

As shown in FIG. 6, the slide portion 16 is provided with a pressing portion 25. In the pressing portion 25, an upper pressing portion 25A projecting downward is arranged on the lower surface of the upper wall of the slide portion 16, and a lower pressing portion 25A projecting upward is arranged on the upper surface of the lower wall of the slide portion 16.

As shown in FIG. 14, a temporary lock receiving portion 26 is open at a position near a front end part in a side wall of the slide portion 16. Further, a complete lock receiving portion 27 is open at a position behind the temporary lock receiving portion 26 in the side wall of the slide portion 16. The temporary lock receiving portion 26 and the complete lock receiving portion 27 are resiliently lockable by the locking projection 28 of the terminal body 15.

As shown in FIG. 17, with the locking projection 28 of the terminal body 15 and the temporary lock receiving portion 26 of the slide portion 16 locked, the slide portion 16 is held at a separation position with respect to the terminal body 15. In this state, as shown in FIG. 5, the pressing portion 25 of the slide portion 16 is disposed behind the rear end edge of the sandwiching portion 18 of the terminal body 15. Further, in this state, an interval between the upper and lower connection pieces 18A, 18B is set to be larger than a diameter of the core wire 13.

As shown in FIG. 16, with the locking projection 28 of the terminal body 15 and the complete lock receiving portion 27 of the slide portion 16 locked, the slide portion 16 is held at a pressing position with respect to the terminal body 15. In this state, as shown in FIG. 6, the upper pressing portion 25A of the slide portion 16 is in contact with the upper surface of the upper connection piece 18A of the terminal body 15 from above. Further, the lower pressing portion 25B of the slide portion 16 is in contact with the lower surface of the lower connection piece 18B of the terminal body 15 from below.

With the slide portion 16 held at the pressing position with respect to the terminal body 15, the upper pressing portion 25A presses the upper connection piece 18A from above, whereby the upper connection piece 18A is resiliently deformed downward. Further, the lower pressing portion 25B presses the lower connection piece 18B from below, whereby the lower connection piece 18B is resiliently deformed upward. In this way, the core wire 13 is disposed to extend in the front-rear direction in a space between the upper and lower connection pieces 18A, 18B and, with the slide portion 16 held at the pressing position with respect to the terminal body 15, the core wire 13 is sandwiched in the vertical direction by the resiliently deformed upper and lower connection pieces 18A, 18B.

With the slide portion 16 held at the pressing position with respect to the terminal body 15, the upper holding protrusion 23A of the upper connection piece 18A presses the core wire 13 from above and the lower holding protrusion 23B of the lower connection piece 18B presses the core wire 13 from below. As just described, the core wire 13 is held in a state bent in the vertical direction by being pressed from above by the upper holding protrusion 23A and from below by the lower holding protrusion 23B disposed at the position shifted in the front-rear direction from the upper holding protrusion 23A. In this way, a holding force for holding the core wire 13 in the terminal body 15 can be improved.

As shown in FIG. 14, a jig contact portion 24 projecting upward from the upper wall is provided in a front end part of the slide portion 16. An unillustrated jig is brought into contact with the jig contact portion 24 from behind and the slide portion 16 is pushed forward by the jig, whereby the slide portion 16 becomes movable forward.

### Core Wire Insertion Opening

A rear end part of the slide portion 16 in the form of a rectangular tube is formed with a core wire insertion opening 29, through which the core wire 13 is inserted into the inside of the slide portion 16.

### Connector Housing

As shown in FIG. 1, the connector housing 30 has a rectangular parallelepiped shape short in the vertical direction and long in the lateral direction. The connector housing 30 is made of insulating synthetic resin. The connector housing 30 includes a plurality of accommodating portions 32 extending in the front-rear direction for accommodating the terminals 12. The accommodating portions 32 are aligned at intervals in the lateral direction in two upper and lower stages. The respective accommodating portions 32 formed in the upper stage and those formed in the lower stage are disposed at positions shifted in the lateral direction. Note that the number and relative arrangement of the accommodating portions 32 can be changed as appropriate.

As shown in FIG. 3, the connector housing 30 is provided with lance receiving portions 33 corresponding to the positions of the locking lances 21 of the terminals 12 with the terminals 12 accommodated in the accommodating portions 32. The locking lance 21 is locked by the lance receiving portion 33 and the terminal 12 is prevented from coming out rearward.

Although not shown, a front end part of the connector housing 30 is formed with front stop portions to be contacted by front end parts of the terminals 12. When the terminal 12 is inserted into the accommodating portion 32, the terminal 12 comes into contact with the front stop portion so as not come out forward from the connector housing 30.

As shown in FIG. 3, the connector housing 30 includes a separation wall 41 partitioning between the accommodating portions 32 formed in the upper stage and those formed in the lower stage. As shown in FIG. 1, the connector housing 30 includes partition walls 42 partitioning between the respective accommodating portions 32 in the lateral direction. The terminals 12 accommodated into the respective accommodating portions 32 are electrically insulated from the terminals 12 adjacent in the lateral direction by the partition walls 42.

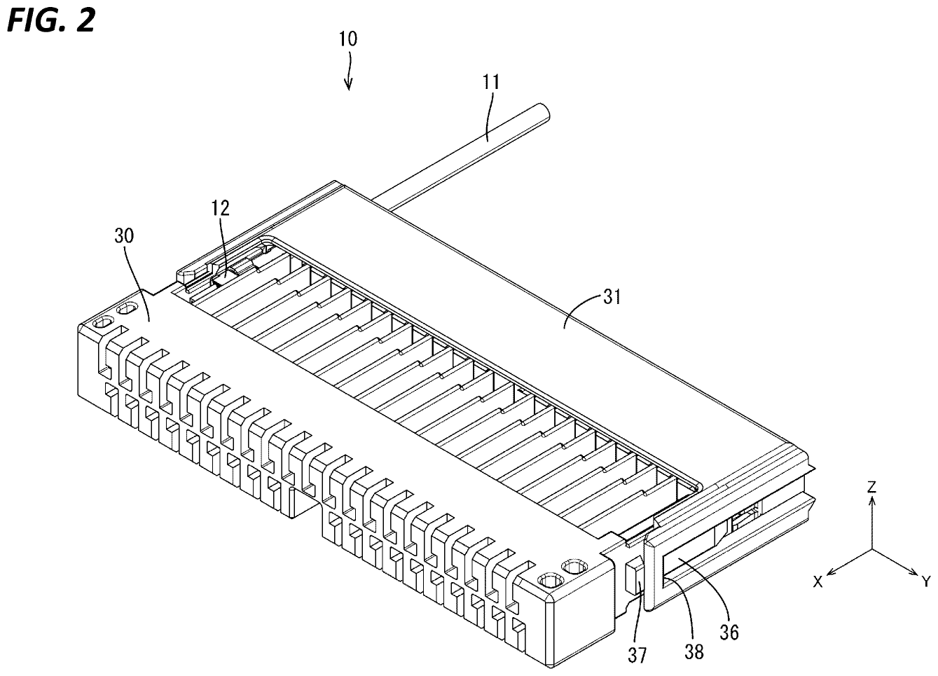

As shown in FIGS. 1 and 2, temporary lock portions 36 and complete lock portions 37 are provided to project outward on both left and right side walls of the connector housing 30. The temporary lock portions 36 are disposed at positions near the rear end part of the connector housing 30, and the complete lock portions 37 are disposed forward of the temporary lock portions 36.

### Rear Holder

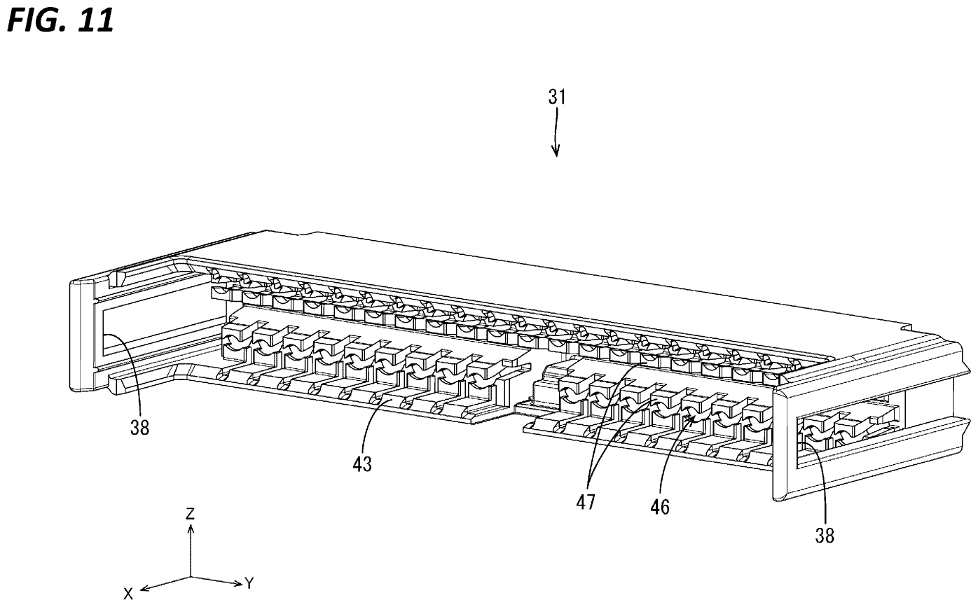

As shown in FIG. 11, the rear holder 31 is in the form of a box open forward. The rear holder 31 is made of insulating synthetic resin. As shown in FIG. 1, the rear holder 31 is fit to a rear half of the connector housing 30 from outside. Lock receiving portions 38 are provided at positions near front end parts on both left and right walls of the rear holder 31. The lock receiving portion 38 is substantially gate-shaped.

As shown in FIG. 2, the rear holder 31 is held at a temporary locking position with respect to the connector housing 30 by locking the temporary lock portions 36 of the connector housing 30 and the lock receiving portions 38 of the rear holder 31. Further, as shown in FIG. 1, the rear holder 31 is held at a complete locking position with respect to the connector housing 30 by locking the complete lock portions 37 of the connector housing 30 and the lock receiving portions 38 of the rear holder 31.

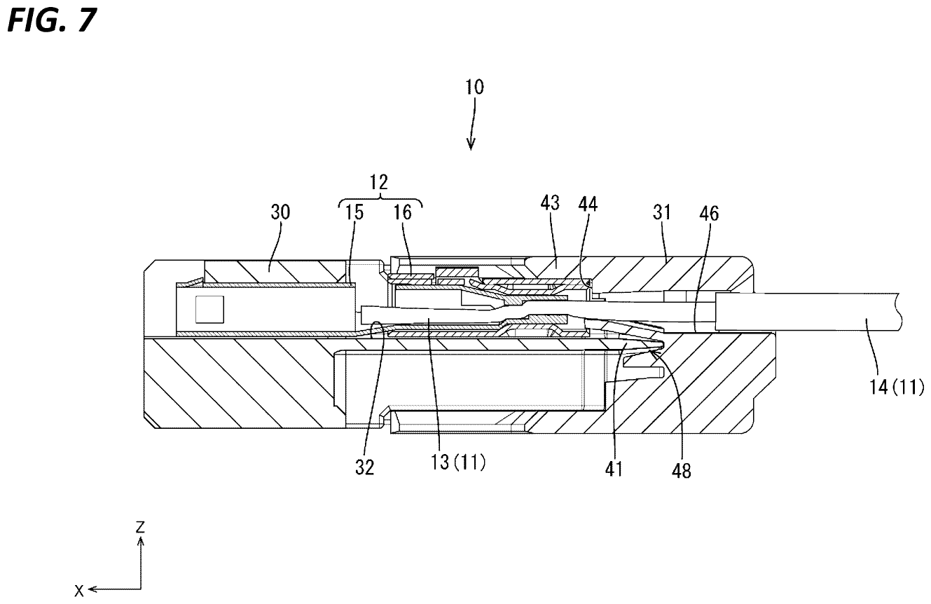

As shown in FIG. 7, the rear holder 31 is provided with a receptacle 43 open forward. The connector housing 30 is fit into the receptacle 43. The rear holder 31 includes locking portions 44 in a rear end part of the receptacle 43. The locking portions 44 are facing rear end parts of the terminals 12 in the front-rear direction. The locking portions 44 are locked to the rear end parts of the terminals 12 in the front-rear direction, whereby the terminals 12 are so retained in the accommodating portions 32 as not to come out rearward.

### Body Portion, Insertion Holes

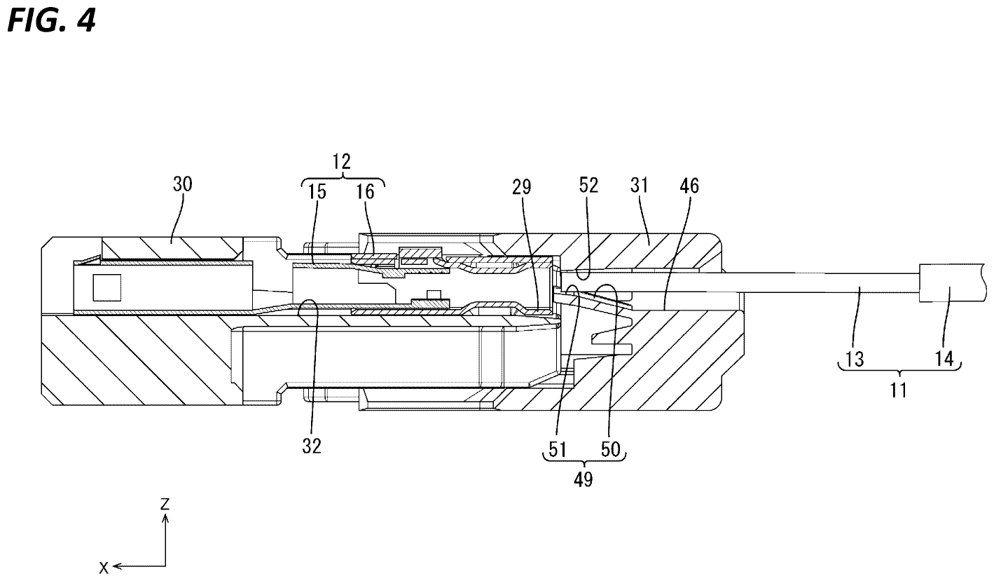

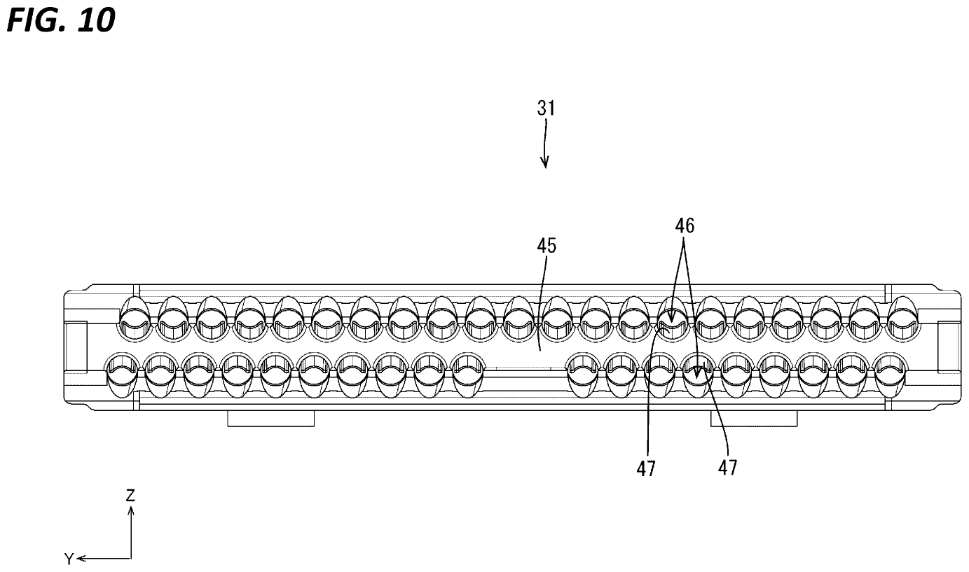

As shown in FIG. 10, the rear holder 31 includes a body portion 45 and a plurality of insertion holes 46 penetrating through the body portion 45 in the front-rear direction. The insertion holes 46 are provided at positions corresponding to the respective accommodating portions 32 of the connector housing 30. That is, the plurality of insertion holes 46 are aligned in the lateral direction in two upper and lower stages. An inner diameter of the insertion hole 46 is set to be equal to or somewhat larger than an outer diameter of the insulation coating 14 of the wire 11. As shown in FIGS. 4 to 8, the wire 11 is inserted into the insertion hole 46. The insertion holes 46 are disposed to communicate with the respective accommodating portions 32 of the connector housing 30 in the front-rear direction.

### Resilient Pieces

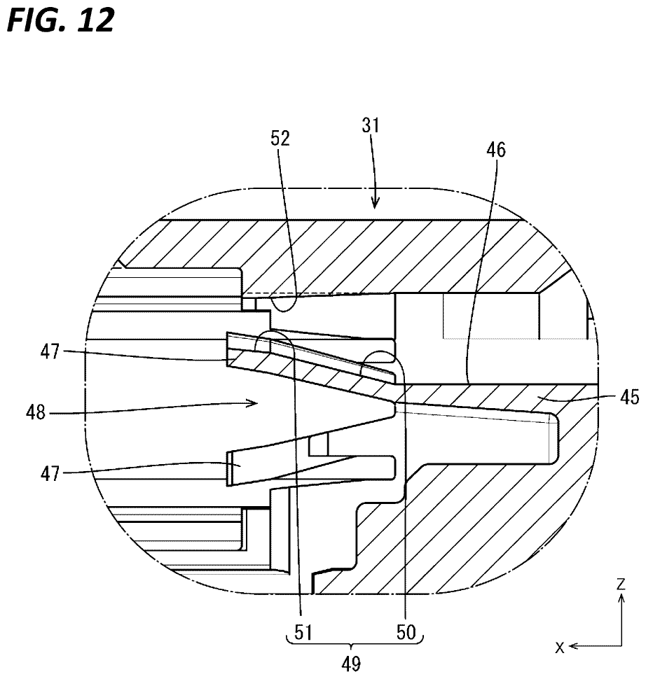

As shown in FIG. 12, the rear holder 31 includes a plurality of resilient pieces 47 extending forward from a vertically central part of the body portion 45. Each resilient piece 47 is disposed on a front side inside each insertion hole 46. As shown in FIG. 10, the resilient piece 47 is provided on a lower side in the insertion hole 46 in the upper stage, and the resilient piece 47 is provided on an upper side in the insertion hole 46 in the lower stage.

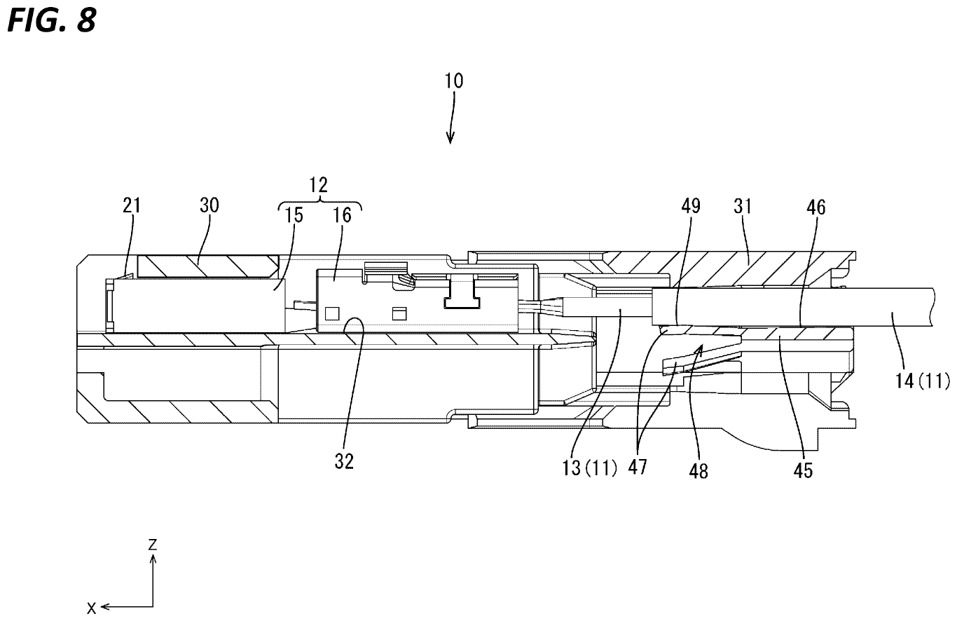

As shown in FIG. 12, the resilient piece 47 is configured to be resiliently deformable in the vertical direction with a rear end part connected to the body portion 45 substantially as a fulcrum. An entrance space 48 is provided between the resilient pieces 47 in the upper and lower stages. Although described in detail later, the resilient piece 47 is resiliently deformed outwardly of the insertion hole 46 by being pressed by the insulation coating 14 of the wire 11 as shown in FIG. 8 in the case of separating the rear holder 31 from the connector housing 30 after the connector 10 is manufactured. That is, the resilient piece 47 in the upper stage is resiliently deformed downward. The resilient piece 47 in the lower stage is not resiliently deformed in FIG. 8, but is resiliently deformed upward. The resilient piece 47 is disposed in the entrance space 48 if being resiliently deformed by being contacted by the insulation coating 14. Note that a cross-section of the terminal 12 is not shown, but only the outer shape of the terminal 12 is shown in FIG. 8.

As shown in FIG. 6, with the rear holder 31 held at the temporary locking position with respect to the connector housing 30, the rear end edge of the separation wall 41 of the connector housing 30 is disposed in front of the entrance space 48. However, since gaps are present between the separation wall 41 and the resilient pieces 47, the resilient deformation of the resilient pieces 47 is not hindered by the separation wall 41. As shown in FIG. 7, with the rear holder 31 held at the complete locking position with respect to the connector housing 30, the separation wall 41 is inserted to the back of the entrance space 48.

Since the resilient pieces 47 in the upper stage and those in the lower stage are symmetrically configured, the configuration of the resilient piece 47 is described based on a positional relationship in the upper stage unless otherwise stated.

### Guide Portion

As shown in FIG. 12, a guide portion 49 is formed on the upper surface of the resilient piece 47. The guide portion 49 is inclined inwardly (here, upwardly) of the insertion hole 46 toward the front. As shown in FIG. 3, the terminal 12 having the slide portion 16 held at the separation position is accommodated into the accommodating portion 32 of the connector housing 30 and, with the rear holder 31 assembled at the temporary locking position with respect to the connector housing 30, a tip part of the guide portion 49 is disposed to face the core wire insertion opening 29 in the front-rear direction. Further, a front end part of the guide portion 49 is disposed in proximity to the core wire insertion opening 29. Therefore, if the wire 11 is inserted into the insertion hole 46, a front end part of the core wire 13 is guided into the core wire insertion opening 29 by sliding in contact with the guide portion 49 as shown in FIG. 4.

### First Guide Portion, Second Guide Portion

As shown in FIG. 12, the guide portion 49 of this embodiment includes a first guide portion 50 and a second guide portion 51 formed continuously in front of the first guide portion 50. The second guide portion 51 is substantially one-fourth of the guide portion 49 on a front side. The first guide portion 50 is a part of the guide portion 49 except the second guide portion 51. An angle of inclination of the first guide portion 50 with respect to an insertion direction (front-rear direction), in which the wire 11 is inserted, is larger than that of the second guide portion 51. Thus, the position of the front end part of the core wire 13 can be largely moved inwardly of the core wire insertion opening 29 by the core wire 13 sliding in contact with the first guide portion 50. On the other hand, since the second guide portion 51 is set to have a small angle of inclination, the second guide portion 51 guides the core wire 13 in a posture extending substantially in the insertion direction into the core wire insertion opening 29 while finely adjusting the position of the front end part of the core wire 13 (see FIG. 4).

For example, if the core wire 13 faces the core wire insertion opening 29 while being largely inclined with respect to the insertion direction, the core wire 13 may not possibly enter the core wire insertion opening 29 by the front end part of the core wire 13 being caught by a rear end part of the upper wall of the slide portion 16. However, since the core wire 13 is caused to face the core wire insertion opening 29 in a state not largely inclined with respect to the insertion direction by the second guide portion 51 in this embodiment, the core wire 13 easily smoothly enters the core wire insertion opening 29.

### Guiding Portion

As shown in FIG. 12, the rear holder 31 includes guiding portions 52 projecting inwardly of the insertion holes 46 from the inner walls of the insertion holes 46. Note that a broken line above the guiding portion 52 represents the inner wall of the insertion hole 46. The guiding portion 52 is disposed on a front side of the insertion hole 46 and located more inwardly (here, downwardly) of the insertion hole 46 toward the front. The core wire 13 easily enters the core wire insertion opening 29 by sliding in contact with the guiding portion 52. Further, the guiding portion 52 is facing the resilient piece 47 in the vertical direction. Thus, the core wire 13 can be guided into the core wire insertion opening 29 from a side opposite to the resilient piece 47 by the guiding portion 52.

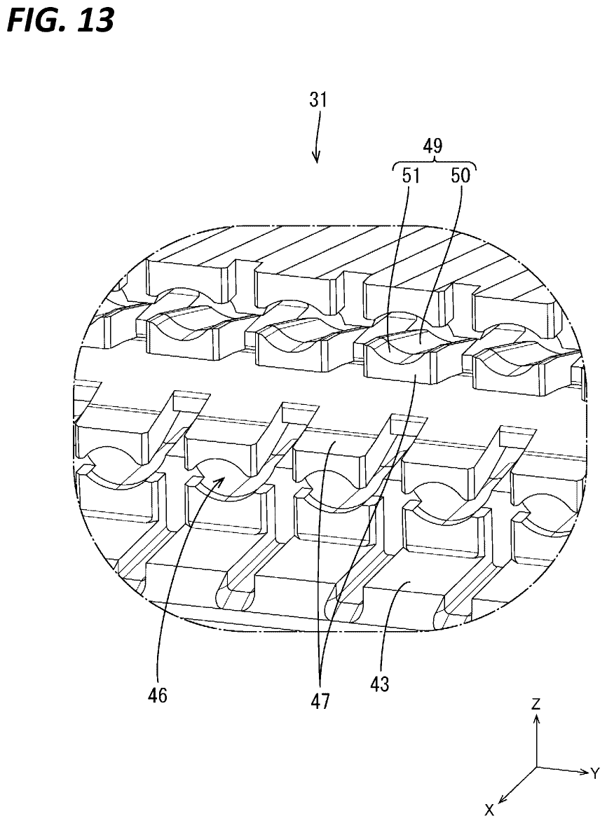

As shown in FIG. 13, the guide portion 49 of this embodiment is in the form of a curved surface concave downward. The guide portion 49 is in the form of a groove extending in the front-rear direction and a substantially U-shaped cross-section. According to this shape, the core wire 13 is easily guided toward a center in a width direction (lateral direction) of the guide portion 49 by the guide portion 49. That is, the core wire 13 is easily guided toward a center of the core wire insertion opening 29.

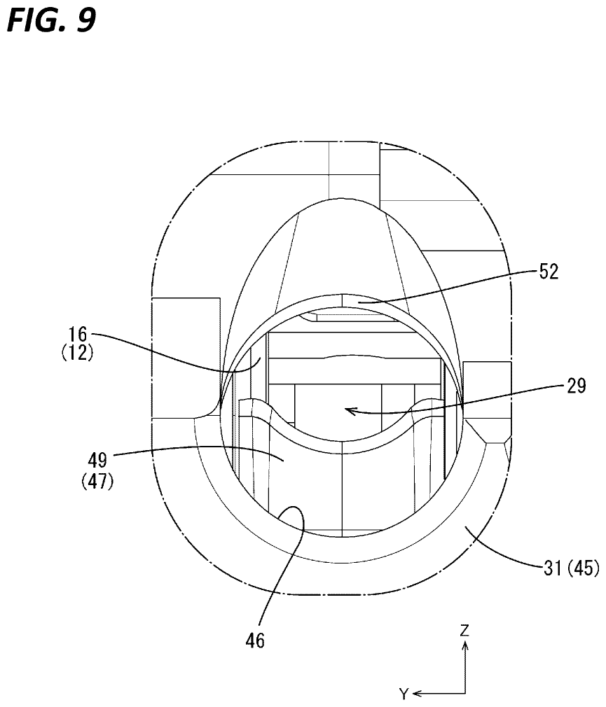

Further, in this embodiment, a radius of curvature of the tip part of the guide portion 49 is smaller than that of the rear end part of the guide portion 49 as shown in FIG. 9. Therefore, the tip part of the guide portion 49 more easily guides the core wire 13 toward the core wire insertion opening 29.

### Connector Manufacturing Method

Next, an example of a manufacturing method of the connector 10 according to this embodiment is described.

The terminal body 15 and the slide portion 16 are formed by a known method. The slide portion 16 is assembled with the terminal body 15 from behind. The front end edge of the slide portion 16 comes into contact with the locking projection 28 of the terminal body 15 from behind and the side wall of the slide portion 16 is expanded and deformed. If the slide portion 16 is pushed further forward, the side wall of the slide portion 16 is restored and the temporary lock receiving portion 26 of the slide portion 16 is locked to the locking projection 28 of the terminal body 15. In this way, the slide portion 16 is held at the separation position with respect to the terminal body 15. In this way, the terminal 12 is obtained (see FIG. 7).

By injection-molding the synthetic resin, the connector housing 30 and the rear holder 31 are formed. After the terminals 12 are inserted into the accommodating portions 32 of the connector housing 30 from behind, the rear holder 31 is assembled with the rear end part of the connector housing 30 from behind. Then, the lock receiving portions 38 of the rear holder 31 ride on the temporary lock portions 36 of the connector housing 30 while being resiliently deformed. If the rear holder 31 is pushed further forward, the lock receiving portions 38 are restored and resiliently locked to the temporary lock portions 36 of the connector housing 30. In this way, the rear holder 31 is held at the temporary locking position with respect to the connector housing 30 (see FIGS. 2 and 3).

The core wire 13 is exposed over a predetermined length in the end part of the wire 11. The front end part of the core wire 13 is inserted from behind into the insertion hole 46 disposed behind the accommodating portion 32 for accommodating the terminal 12. As shown in FIG. 4, the core wire 13 inserted into the insertion hole 46 slides in contact with the guide portion 49 of the rear holder 31. Since the guide portion 49 is inclined inwardly of the insertion hole 46 toward the front, the core wire 13 is guided into the core wire insertion opening 29. The core wire 13 is guided into the core wire insertion opening 29 similarly by the guiding portion 52 provided to face the guide portion 49 in the vertical direction.

Since the guide portion 49 has a substantially U-shaped cross-section and is in the form of a groove, the core wire 13 is guided toward the center also in the width direction (lateral direction) of the resilient piece 47. Thus, the core wire 13 is easily guided toward the center of the core wire insertion opening 29.

Since the second guide portion 51 having a small angle of inclination with respect to the insertion hole of the wire 11 is provided on a tip side of the guide portion 49 in this embodiment, the core wire 13 approaching the core wire insertion opening 29 is in a posture not inclined very much with respect to the insertion direction of the wire 11. In this way, the core wire 13 is more easily guided into the core wire insertion opening 29. Further, since the radius of curvature of the guide portion 49 is smaller in the tip part of the guide portion 49 than in the rear end part of the guide portion 49, the core wire 13 is even more easily guided toward the widthwise center of the guide portion 49 near the core wire insertion opening 29.

As described above, the core wire 13 of the wire 11 inserted into the insertion hole 46 enters the core wire insertion opening 29 by sliding in contact with the guide portion 49.

If the wire 11 is pushed further forward, the core wire 13 enters the inside of the terminal body 15 and is disposed at the position of the sandwiching portion 18 in the front-rear direction. That is, the core wire 13 passes between the upper and lower connection pieces 18A, 18B (see FIG. 5). Note that, although the front end part of the insulation coating 14 is located near the rear end part of the resilient piece 47 in FIG. 5, the insulation coating 14 may, for example, reach the front end part of the insertion hole 46 and deflect the resilient piece 47.

Subsequently, the unillustrated jig is pushed into contact with the jig contact portion 24 from behind and the slide portion 16 is moved forward with respect to the terminal body 15. At this time, the locking of the locking projection 28 of the terminal body 15 and the temporary lock receiving portion 26 of the slide portion 16 is released and the side wall of the slide portion 16 rides on the locking projection 28 and is expanded and deformed.

If the jig contact portion 24 is pushed further forward by the jig, the side wall of the slide portion 16 is restored and the locking projection 28 of the terminal body 15 and the complete lock receiving portion 27 of the slide portion 16 are resiliently locked. In this way, the slide portion 16 is held at the pressing position with respect to the terminal body 15 (see FIG. 6).

When the slide portion 16 moves to the pressing position with respect to the terminal body 15, the upper pressing portion 25A of the slide portion 16 presses the upper connection piece 18A of the terminal body 15 downward. Further, the lower pressing portion 25B of the slide portion 16 presses the lower connection piece 18B of the terminal body 15 upward. In this way, the core wire 13 is vertically sandwiched by the upper and lower connection pieces 18A, 18B and the wire 11 and the terminal 12 are electrically connected.

Subsequently, if the rear holder 31 is pushed forward, the lock receiving portions 38 of the rear holder 31 ride on the complete lock portions 37 of the connector housing 30 and are resiliently deformed. If the rear holder 31 is pushed further forward, the lock receiving portions 38 are locked to the complete lock portions 37. In this way, the rear holder 31 is held at the complete locking position with respect to the connector housing 30 (see FIGS. 7 and 1). In the above way, the manufacturing of the connector 10 is completed.

In a state where the manufacturing of the connector 10 is completed, the resilient piece 47 is preferably in a natural state without being pressed by the insulation coating 14 as shown in FIG. 7. This is because the strength of the resilient piece 47 may be reduced with the resilient piece 47 resiliently deformed.

### Repair Operation of Terminal

Next, an example of a repair operation of the terminal 12 in the connector 10 of this embodiment is described. Note that the repair of the terminal 12 means the exchange of the terminal 12 having a problem in the connector 10 for a new terminal 12.

First, the rear holder 31 is removed from the connector housing 30. The locking of the lock receiving portions 38 of the rear holder 31 with the complete lock portions 37 and the temporary lock portions 36 is released by deflecting the lock receiving portions 38 outward, and the rear holder 31 is moved rearward.

If the rear holder 31 is moved rearward, the guide portions 49 contact the insulation coatings 14 of the wires 11. In this embodiment, since the guide portion 49 is provided on the resiliently deformable resilient piece 47, the rear holder 31 can be moved further rearward and separated from the connector housing 30 by the insulation coatings 14 of the wires 11 resiliently deforming the resilient pieces 47 as shown in FIG. 8.

With the rear holder 31 separated rearward from the temporary locking position, the terminal 12 to be repaired can be taken out from the accommodating portion 32 since the space behind the accommodating portion 32 can be utilized. In particular, the locking lance 21 of the terminal body 15 is squashed with a jig or the like and the terminal 12 is pulled out rearward.

Subsequently, the new terminal 12 is accommodated into the accommodating portion 32, and the connector 10 is configured again in the same way as the manufacturing method described above. Alternatively, the connector 10 may be configured by accommodating the new terminal 12 connected to the wire 11 in advance into the accommodating portion 32.

### Functions and Effects of Embodiment

According to the embodiment, the following functions and effects are achieved.

The connector 10 according to the embodiment is to be connected to the wires 11 each including the core wire 13 and the insulation coating 14 covering the outer periphery of the core wire 13 and extending in the front-rear direction, and provided with the terminals 12 to be connected to the core wires 13, the connector housing 30 for accommodating the terminals 12 inside and the rear holder 31 to be attached to the rear part of the connector housing 30. The terminal 12 includes the terminal body 15 and the slide portion 16 slidable in the front-rear direction while being externally fit to the terminal body 15. The terminal body 15 includes the sandwiching portion 18 for sandwiching the core wire 13. The slide portion 16 includes the core wire insertion opening 29, through which the core wire 13 is inserted from behind, and the pressing portion 25 for pressing the sandwiching portion 18 against the core wire 13 inserted through the core wire insertion opening 29. The rear holder 31 includes the body portion 45, the insertion holes 46 penetrating through the body portion 45 in the front-rear direction, the wires 11 being inserted inside the insertion holes 46, and the resilient pieces 47 extending from the body portion 45 and disposed on the front sides inside the insertion holes 46. The resilient piece 47 is resiliently deformable in a direction intersecting an extension direction of the wire 11 and formed with the guide portion 49 inclined inwardly of the insertion hole 46 toward the front.

According to this configuration, the insertion of the core wire 13 into the core wire insertion opening 29 can be guided by the guide portion 49. If the rear holder 31 is provided with the guide portion 49, the guide portion 49 contacts the insulation coating 14 when the rear holder 31 is separated from the connector housing 30 for the repair of the terminal 12 or the like. In the above configuration, since the guide portion 49 is provided on the resilient piece 47 resiliently deformable in the direction intersecting the extension direction of the wire 11, the rear holder 31 is easily separated from the connector housing 30 by the insulation coating 14 resiliently deforming the resilient piece 47.

In the embodiment, the tip part of the guide portion 49 is proximate to the core wire insertion opening 29.

According to this configuration, the insertion of the core wire 13 into the core wire insertion opening 29 is more easily guided by the guide portion 49.

In the embodiment, the guide portion 49 has a curved surface shape.

According to this configuration, the core wire 13 is easily guided toward the center of the core wire insertion opening 29.

In the embodiment, the radius of curvature of the tip part of the guide portion 49 is smaller than that of the rear end part of the guide portion 49.

According to this configuration, the core wire 13 is even more easily guided toward the center of the core wire insertion opening 29 by the tip part of the guide portion 49.

In the embodiment, the guide portion 49 includes the first guide portion 50 and the second guide portion 51 disposed continuously in front of the first guide portion 50, and the second guide portion 51 is more gently inclined than the first guide portion 50.

According to this configuration, the inclination of the core wire 13 with respect to the insertion direction can be suppressed by the second guide portion 51 near the core wire insertion opening 29 while the position of the core wire 13 is guided inwardly of the core wire insertion opening 29 by the first guide portion 50. Thus, the insertion of the core wire 13 into the core wire insertion opening 29 is even more easily guided.

In the embodiment, the rear holder 31 includes the guiding portions 52 projecting inwardly of the insertion holes 46 from the inner walls of the insertion holes 46 toward the front, and the guiding portion 52 is disposed to face the guide portion 49 in a resiliently deformable direction of the resilient piece 47.

According to this configuration, the insertion of the core wire 13 into the core wire insertion opening 29 is even more easily guided by the guiding portion 52.

### Other Embodiments

(1) Although one resilient piece 47 is provided in each insertion hole 46 and disposed on the upper or lower side of each insertion hole 46 in the above embodiment, there is no limitation to this and the number and positions of the resilient pieces provided in each insertion hole may be changed as appropriate. For example, two resilient pieces may be provided on the upper and lower sides of each insertion hole.
(2) Although the rear holder 31 is held at the temporary locking position and the complete locking position with respect to the connector housing 30 in the above embodiment, there is no limitation to this and a rear holder may be held at one locking position with respect to the connector housing.

### LIST OF REFERENCE NUMERALS

10: connector
11: wire
12: terminal
13: core wire
14: insulation coating
15: terminal body
16: slide portion
17: connecting tube portion
18: sandwiching portion
18A: upper connection piece
18B: lower connection piece
20: base portion
21: locking lance
23A: upper holding protrusion
23B: lower holding protrusion
24: jig contact portion
25: pressing portion
25A: upper pressing portion
25B: lower pressing portion
26: temporary lock receiving portion
27: complete lock receiving portion
28: locking projection
29 core wire insertion opening
30: connector housing
31: rear holder
32: accommodating portion
33: lance receiving portion
36: temporary lock portion
37: complete lock portion
38: lock receiving portion
41 separation wall
42 partition wall
43: receptacle
44: locking portion
45: body portion
46 insertion hole
47 resilient piece
48: entrance space
49: guide portion
50; first guide portion
51: second guide portion
52: guiding portion

1. A connector to be connected to a wire including a core wire and an insulation coating covering an outer periphery of the core wire and extending in a front-rear direction, comprising:
a terminal to be connected to the core wire;
a connector housing for accommodating the terminal inside; and
a rear holder to be attached to a rear part of the connector housing,
the terminal including a terminal body and a slide portion slidable in the front-rear direction while being externally fit to the terminal body,
the terminal body including a sandwiching portion for sandwiching the core wire,
the slide portion including a core wire insertion opening, the core wire being inserted through the core wire insertion opening from behind, and a pressing portion for pressing the sandwiching portion against the core wire inserted through the core wire insertion opening,
the rear holder including a body portion, an insertion hole penetrating through the body portion in the front-rear direction, the wire being inserted through the insertion hole, and a resilient piece extending from the body portion, the resilient piece being disposed on a front side inside the insertion hole,
the resilient piece being resiliently deformable in a direction intersecting an extension direction of the wire, and
the resilient piece being formed with a guide portion inclined inwardly of the insertion hole toward front.

2. The connector of claim 1, wherein a tip part of the guide portion is proximate to the core wire insertion opening.

3. The connector of claim 1, wherein the guide portion has a curved surface shape.

4. The connector of claim 3, wherein a radius of curvature of a tip part of the guide portion is smaller than a radius of curvature of a rear end part of the guide portion.

5. The connector of claim 1, wherein:
the guide portion includes a first guide portion and a second guide portion continuously disposed in front of the first guide portion, and
the second guide portion is more gently inclined than the first guide portion.

6. The connector of claim 1, wherein:
the rear holder includes a guiding portion projecting inwardly of the insertion hole from an inner wall of the insertion hole toward the front, and
the guiding portion is disposed to face the guide portion in a resiliently deformable direction of the resilient piece.
